(19) United States
(12) Patent Application Publication
(10) Pub. No.: US 2019/0200127 A1
(43) Pub. Date: Jun. 27, 2019

(54) Speaker Syncronizing System

(71) Applicants: Andrew Brown, Windsor (CA); Anthony Mulder, Windsor (CA)

(72) Inventors: Andrew Brown, Windsor (CA); Anthony Mulder, Windsor (CA)

(21) Appl. No.: 15/855,166

(22) Filed: Dec. 27, 2017

(51) Int. Cl. H04R 3/12; G06F 3/16

(52) U.S. Cl. CPC H04R 3/12; H04R 2420/07; G06F 3/165

(57) ABSTRACT

A speaker synchronizing system for pairing multiple speakers to a single electronic device includes a housing that has a front wall, a back wall and a perimeter wall that is attached to and extends between the front wall and the back wall. A plurality of speakers is included wherein each of the speakers is positioned remote of the housing. An extrinsic electronic device is positioned remote of the housing and has an audio file stored thereon. A communication unit is mounted in the housing and is in electronic communication with each of the speakers and the extrinsic electronic device. The communication unit sends a signal that is discretely assigned to each of the speakers.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

(1) Field of the Invention

(2) Description of Related Art Including Information Disclosed Under 37 CFR 1.97 and 1.98.

The disclosure and prior art relates to speaker coupling devices and more particularly pertains to a new speaker coupling device for pairing multiple speakers to a single electronic device.

### (h) BRIEF SUMMARY OF THE INVENTION

An embodiment of the disclosure meets the needs presented above by generally comprising a housing that has a front wall, a back wall and a perimeter wall that is attached to and extends between the front wall and the back wall. A plurality of speakers is included wherein each of the speakers is positioned remote of the housing. An extrinsic electronic device is positioned remote of the housing and has an audio file stored thereon. A communication unit is mounted in the housing and is in electronic communication with each of the speakers and the extrinsic electronic device. The communication unit sends a signal that is discretely assigned to each of the speakers.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top side view of a speaker synchronizing system according to an embodiment of the disclosure.

FIG. 2 is a side view of an embodiment of the disclosure.

FIG. 3 is a top view of an embodiment of the disclosure.

FIG. 4 is a block schematic diagram of an embodiment of the disclosure.

### (j) DETAILED DESCRIPTION OF THE INVENTION

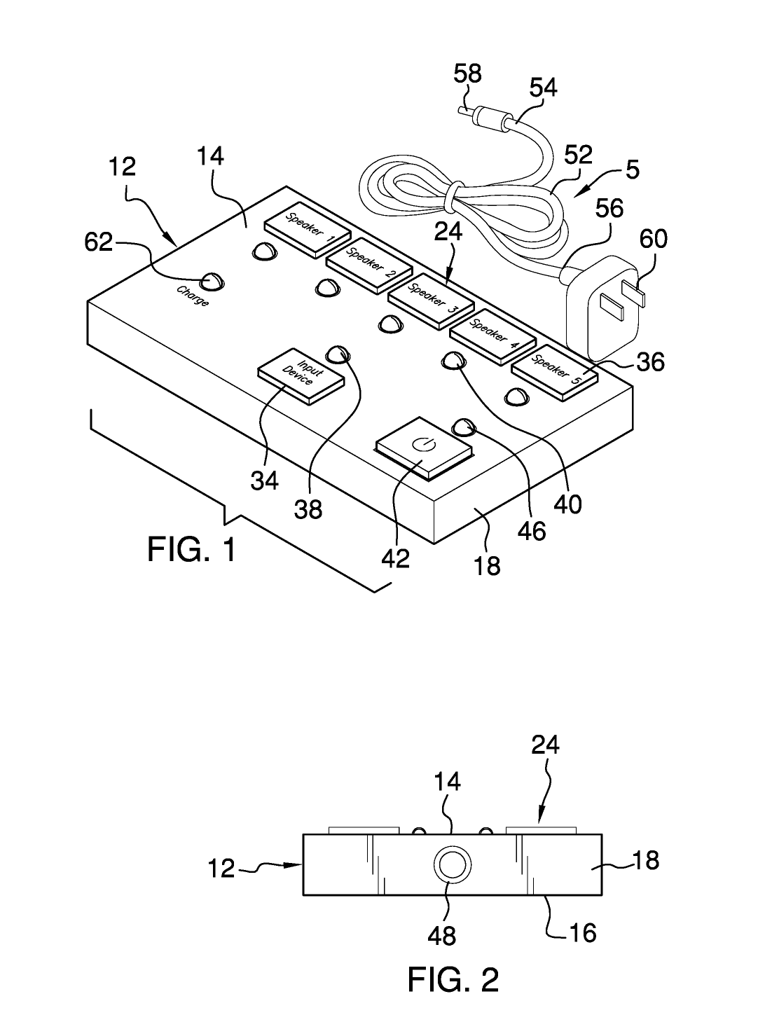

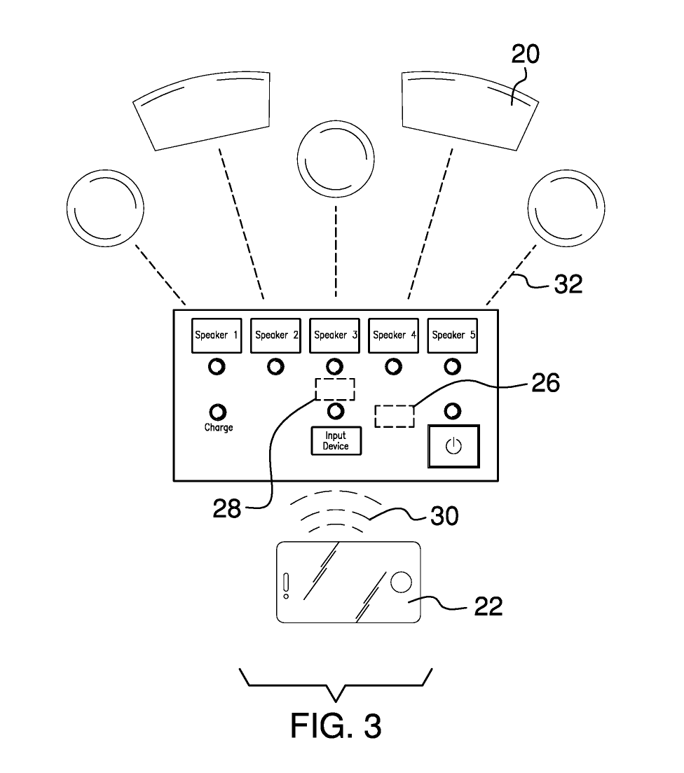

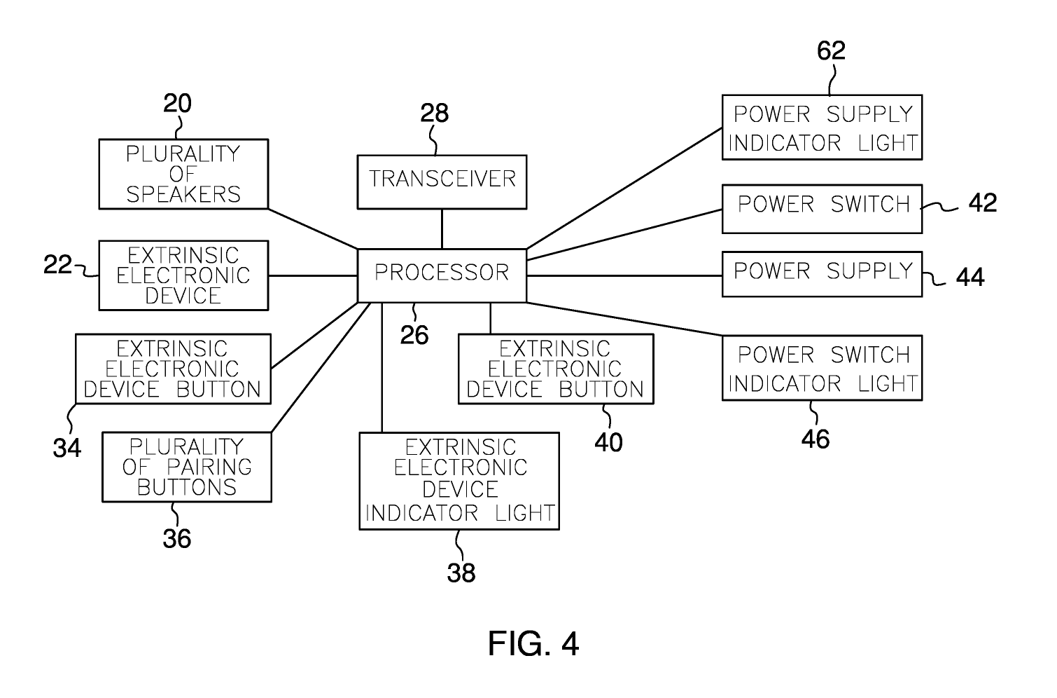

With reference now to the drawings, and in particular to FIGS. 1 through 4 thereof, a new speaker coupling device embodying the principles and concepts of an embodiment of the disclosure and generally designated by the reference numeral 10 will be described.

As best illustrated in FIGS. 1 through 4, the speaker synchronizing system 10 generally comprises a housing 12 that has a front wall 14, a back wall 16 and a perimeter wall 18 that is attached to and extends between the front wall 14 and the back wall 16. A plurality of speakers 20 is included wherein each of the speakers 20 is positioned remote of the housing 12. An extrinsic electronic device 22 is positioned remote of the housing 12. The extrinsic electronic device 22 has an audio file stored thereon. The extrinsic electronic device includes but is not limited to cellular phones, electronic music playing devices and other electronic devices capable of storing audio files thereon.

A communication unit 24 is mounted in the housing 12. The communication unit 24 is in electronic communication with each of the speakers 20 and the extrinsic electronic device 22. The communication unit 24 sends a signal that is discretely assigned to each of the speakers 20. The communication unit 24 comprises a processor 26. A transceiver 28 is electrically coupled to the processor 26. The transceiver 28 has a receiving channel 30 and a plurality of discrete transmission channels 32. Each of the speakers 20 is selectively assigned and wirelessly coupled to an associated one of the discrete transmission channels 32 when the associated discrete transmission channel 32 is actuated. The extrinsic electronic device 22 is wirelessly coupled to the receiving channel 30 when the receiving channel 30 is actuated. The extrinsic electronic device 22 selectively sends the audio file to the transceiver 28 when the receiving channel 30 is actuated. The transceiver 28 transmits the audio file from the extrinsic electronic device 22 to each of the speakers 20 when the associated discrete transmission channel 32 is actuated. Each of the discrete transmission channels 32 may connect to the associated speaker 20 through a Bluetooth connection, but may also comprise other wireless connection means.

An extrinsic electronic device button 34 is electrically coupled to the processor 26. The extrinsic electronic device button 34 is associated with the receiving channel 30 and is pressed to turn the receiving channel 30 on or off. The receiving channel 30 is in electronic communication with the extrinsic electronic device 22 when the receiving channel 30 is turned on.

A plurality of pairing buttons 36 each is electrically coupled to the processor 26. Each of the pairing buttons 36 actuates an associated one of the discrete transmission channels 32 wherein each of the pairing buttons 36 turns the associated one of the discrete transmission channels 32 on or off.

An extrinsic electronic device indicator light 38 is electrically coupled to the processor 26 and is actuated on when the receiving channel 30 is turned on. The extrinsic electronic device indicator light 38 is positioned adjacent to the extrinsic electronic device button 34. A plurality of speaker indicator lights 40 is included wherein each of the speaker indicator lights 40 is electrically coupled to the processor 26. Each of the speaker indicator lights 40 is assigned to a corresponding one of the discrete transmission channels 32 such that each of the speaker indicator lights 40 is turned on when the corresponding discrete transmission channels 32 is turned on. Each of the speaker indicator lights 40 is positioned adjacent to a corresponding one of the pairing button 36.

A power switch 42 is actuated to power the processor 26 on or off. A power supply 44 is coupled to the housing 12 and is electrically coupled to the processor 26. The power supply 26 comprises at least one rechargeable battery. A power switch indicator light 46 is mounted to the housing 12 and is electrically coupled to the processor 26. The power switch indicator light 46 is turned on when the processor 26 is turned on. A contact 48 is positioned on the housing 12 and is electrically coupled to the power supply 44.

A charger 50 is positioned remote of the housing 12. The charger 50 comprises a cord 52 that has a first end 54 and a second end 56. A first plug 58 is electrically coupled to the first end 54 of the cord 52 and is selectively inserted into the contact 48. A second plug 60 is electrically coupled to the second end 56 wherein the second plug is electrically coupleable to a power source. A power supply indicator light 62 is mounted on the housing 12 and is electrically coupled to the processor 26. The power supply indicator light turns 62 on when the charger 50 is electrically coupled to the contact 48 and the power source.

In use, an extrinsic electronic device 22 is electrically coupled to the communication unit 24 when the extrinsic electronic device button 34 is pressed to open the receiving channel 30. Each of the speakers 20 are associated and connected to one of the discrete transmission channels 32, when the associated one of the pairings buttons 36 is pressed to actuate the associated discrete transmission channel 32. When the extrinsic electronic device 22 is actuated to play the audio file, the transceiver 28 receives the audio file and transmits the audio file through each of the connected speakers 20.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A speaker pairing system for pairing multiple wireless speakers to a single extrinsic electronic device, said system comprising
a housing having a front wall, a back wall and a perimeter wall being attached to and extending between said front wall and said back wall;
a plurality of speakers, each of said speakers being positioned remote of said housing;
an extrinsic electronic device being positioned remote of said housing, said extrinsic electronic device having an audio file stored thereon; and
a communication unit being mounted in said housing, said communication unit being in electronic communication with each of said speakers and said extrinsic electronic device, said communication unit sending a signal being discretely assigned to each of said speakers, said communication unit comprising
a processor; and
a transceiver being electrically coupled to said processor, said transceiver having a receiving channel, said transceiver having a plurality of discrete transmission channels, each of said speakers being selectively assigned and wirelessly coupled to an associated one of said discrete transmission channels when said associated discrete transmission channel is actuated, said extrinsic electronic device being wirelessly coupled to said receiving channel when said receiving channel is actuated, said extrinsic electronic device selectively sending said audio file to said transceiver when said receiving channel is actuated, said transceiver transmitting said audio file from said extrinsic electronic device to each of said speakers when said associated discrete transmission channel is actuated.

2. (canceled)

3. The speaker pairing system according to claim 1, wherein said communication unit further comprises an extrinsic electronic device button being electrically coupled to said processor, said extrinsic electronic device button being associated with said receiving channel, said extrinsic electronic device button being pressed to turn said receiving channel on or off, said receiving channel being in electronic communication with said extrinsic electronic device when said receiving channel is turned on.

4. The speaker pairing system according to claim 1, wherein said communication unit further comprises a plurality of pairing buttons each being electrically coupled to said processor, each of said pairing buttons actuating an associated one of said discrete transmission channels, each of said pairing buttons turning said associated one of said discrete transmission channels on or off.

5. The speaker pairing system according to claim 3, wherein said communication unit further comprises an extrinsic electronic device indicator light being electrically coupled to said processor and being actuated on when said receiving channel is turned on, said extrinsic electronic device indicator light being positioned adjacent to said extrinsic electronic device button.

6. The speaker pairing system according to claim 4, wherein said communication unit further comprises a plurality of speaker indicator lights, each of said speaker indicator lights being electrically coupled to said processor, each of said speaker indicators lights being assigned to a corresponding one of said discrete transmission channels such that each of said speaker indicator lights is turned on when said corresponding discrete transmission channels is turned on, each of said speaker indicator lights being positioned adjacent to a corresponding one of said pairing buttons.

7. The speaker pairing system according to claim 1, wherein said communication unit further comprises:
a power switch being actuated to power said processor on or off; and
a power supply being coupled to said housing, said power supply being electrically coupled to said processor.

8. A speaker pairing system for pairing multiple wireless speakers to a single extrinsic electronic device, said system comprising
a housing having a front wall, a back wall and a perimeter wall being attached to and extending between said front wall and said back wall;
a plurality of speakers, each of said speakers being positioned remote of said housing;
an extrinsic electronic device being positioned remote of said housing, said extrinsic electronic device having an audio file stored thereon;
a communication unit being mounted in said housing, said communication unit being in electronic communication with each of said speakers and said extrinsic electronic device, said communication unit sending a signal being discretely assigned to each of said speakers, said communication unit comprising:
a processor;
a transceiver being electrically coupled to said processor, said transceiver having a receiving channel, said transceiver having a plurality of discrete transmission channels, each of said speakers being selectively assigned and wirelessly coupled to an associated one of said discrete transmission channels when said associated discrete transmission channel is actuated, said extrinsic electronic device being wirelessly coupled to said receiving channel when said receiving channel is actuated, said extrinsic electronic device selectively sending said audio file to said transceiver when said receiving channel is actuated, said transceiver transmitting said audio file from said extrinsic electronic device to each of said speakers when said associated discrete transmission channel is actuated;
an extrinsic electronic device button being electrically coupled to said processor, said extrinsic electronic device button being associated with said receiving channel, said extrinsic electronic device button being pressed to turn said receiving channel on or off, said receiving channel being in electronic communication with said extrinsic electronic device when said receiving channel is turned on;
a plurality of pairing buttons each being electrically coupled to said processor, each of said pairing buttons actuating an associated one of said discrete transmission channels, each of said pairing buttons turning said associated one of said discrete transmission channels on or off;
an extrinsic electronic device indicator light being electrically coupled to said processor and being actuated on when said receiving channel is turned on, said extrinsic electronic device indicator light being positioned adjacent to said extrinsic electronic device button;
a plurality of speaker indicator lights, each of said speaker indicator lights being electrically coupled to said processor, each of said speaker indicators lights being assigned to a corresponding one of said discrete transmission channels such that each of said speaker indicator lights is turned on when said corresponding discrete transmission channels is turned on, each of said speaker indicator lights being positioned adjacent to a corresponding one of said pairing buttons;
a power switch being actuated to power said processor on or off; and
a power supply being coupled to said housing, said power supply being electrically coupled to said processor.
